(19) United States
(12) Patent Application Publication
(10) Pub. No.: US 2026/0342009 A1
(43) Pub. Date: Oct. 29, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Daisuke SAITO, Mie (JP)

(21) Appl. No.: 19/107,023

(22) PCT Filed: Aug. 29, 2023
(86) PCT No.: PCT/JP2023/031108

§ 371 Date: Feb. 27, 2025

(30) Foreign Application Priority Data
Sep. 2, 2022 (JP) 2022-139803

(51) Int. Cl. H01R 13/631; H01R 13/502; H01R 13/629

(52) U.S. Cl. CPC H01R 13/631; H01R 13/502; H01R 13/62933

(57) ABSTRACT

In a connector, a pair of inner wall surface (upper inner wall surface, lower inner wall surface) and a pair of outer wall surface (upper outer wall surface, lower outer wall surface) constitute two sets of facing wall surfaces (upper facing wall surface set, lower facing wall surface set), a combination of the upper inner wall surface and the upper outer wall surface facing each other being one set and a combination of the lower inner wall surface and the lower outer wall surface facing each other being one set. A thread rib to be squeezed and deformed in an assembled state of a male housing and a moving plate is provided only on the lower facing wall surface set, out of two sets of the facing wall surfaces (upper facing wall surface set, lower facing wall surface set).

### TECHNICAL FIELD

The present disclosure relates to a connector.

### BACKGROUND

Patent Document 1 discloses a connector provided with a housing for accommodating a mating connector inside and interference ribs provided in the housing to interfere with the mating housing.

Such interference ribs are for preventing prying due to a clearance between the housings. By squeezing and deforming the ribs, the housings are positioned without being inclined and terminal fittings are concentrically aligned in position.

### PRIOR ART DOCUMENT

### Patent Document

Patent Document 1: JP 2011-018538 A

### SUMMARY OF THE INVENTION

### Problems to be Solved

The ribs of Patent Document 1 are arranged on two sides facing each other. Deformation amounts of the both thread ribs are determined according to the shapes and projecting dimensions of the thread ribs. However, since the shapes and projecting dimensions of the thread ribs vary within tolerance ranges, it is unavoidable that the deformation amounts of the both thread ribs also vary. Therefore, a positional relationship of both components is not constant in a projecting direction of the thread ribs.

A connector of the present disclosure was completed on the basis of the above situation and aims to keep a positional relationship of a first component and a second component to be assembled with each other constant.

### Means to Solve the Problem

The present disclosure is directed to a connector with a first component having a pair of inner wall surfaces arranged to face each other and a second component having a pair of outer wall surfaces arranged back to back, the second component being assembled with the first component with the pair of outer wall surfaces caused to face the pair of inner wall surfaces, the pair of inner wall surfaces and the pair of outer wall surfaces constituting two sets of facing wall surfaces, a combination of one inner wall surface and one outer wall surface facing each other being one set, and a thread rib to be squeezed and deformed in an assembled state of the first component and the second component being provided only on one set of the facing wall surfaces, out of the two sets of the facing wall surfaces.

### Effect of the Invention

According to the present disclosure, a positional relationship of a first component and a second component to be assembled with each other can be kept constant.

### BRIEF DESCRIPTION OF THE DRAWINGS

FIG. 1 is a perspective view of a connector of a first embodiment.

FIG. 2 is a perspective view showing a disassembled state of the connector.

FIG. 3 is a perspective view of a male housing.

FIG. 4 is a perspective view of a moving plate.

FIG. 5 is a side view in section of the connector before the connection of male terminal fittings and female terminal fittings is started.

FIG. 6 is an enlarged view of an upper end side and a lower end side in the connector of FIG. 5.

FIG. 7 is a back view of the connector before the connection of the both terminal fittings is started.

FIG. 8 is an enlarged view of a lower end side in the connector of FIG. 7.

FIG. 9 is an enlarged view of a left upper end side and a left lower end side in the connector of FIG. 7.

FIG. 10 is a section along A-A of FIG. 7.

FIG. 11 is an enlarged view of the left upper end side and a right upper end side in the connector of FIG. 7.

FIG. 12 is a view, corresponding to FIG. 5, in a state where the connection of the male housing and a female housing is completed.

FIG. 13 is an enlarged view of a part of the left upper end side and a part of the right upper end side in a cross-section along D-D of FIG. 5.

FIG. 14 is a section along C-C of FIG. 7 showing only the male housing.

FIG. 15 is a section, corresponding to FIG. 14, of a connector of a second embodiment.

FIG. 16 is a section, corresponding to FIG. 14, of a connector of another embodiment.

### DETAILED DESCRIPTION TO EXECUTE THE INVENTION

### Description of Embodiments of Present Disclosure

First, embodiments of the present disclosure are listed and described.
(1) The connector of the present disclosure is provided with a first component having a pair of inner wall surfaces arranged to face each other and a second component having a pair of outer wall surfaces arranged back to back, the second component being assembled with the first component with the pair of outer wall surfaces caused to face the pair of inner wall surfaces, the pair of inner wall surfaces and the pair of outer wall surfaces constituting two sets of facing wall surfaces, a combination of one inner wall surface and one outer wall surface facing each other being one set, and a thread rib to be squeezed and deformed in an assembled state of the first component and the second component being provided only on one set of the facing wall surfaces, out of the two sets of the facing wall surfaces.

According to the configuration of the present disclosure, in the assembled state of the first and second components, the inner wall surface and the outer wall surface are directly in contact in the facing wall surface set where the thread rib is not arranged, whereby a positional relationship of the first and second components can be kept constant.
(2) Preferably, in (1), the first component has two pairs of the inner wall surfaces having orthogonal facing directions, the second component has two pairs of the outer wall surfaces having orthogonal facing directions, and the thread ribs are arranged only on two sets of the facing wall surfaces positioned to be orthogonal to each other, out of two pairs of facing wall surface sets. According to this configuration, the positional relationship of the both components can be kept constant in two-dimensional directions orthogonal to each other.
(3) Preferably, in (1) or (2), the first component and the second component are assembled in parallel in a length direction of the thread rib, the first component includes a plurality of the thread ribs, and positions of front ends in an assembly direction of the plurality of thread ribs are different among the plurality of thread ribs. According to this configuration, in the process of assembling the first and second components, connection resistance due to the squeezing deformation of the thread ribs is maximum when the squeezing deformation of the thread ribs starts. A peak value of the connection resistance can be reduced by making formation ranges of the plurality of thread ribs in the assembly direction different.

### Details of Embodiments of Present Disclosure

### First Embodiment

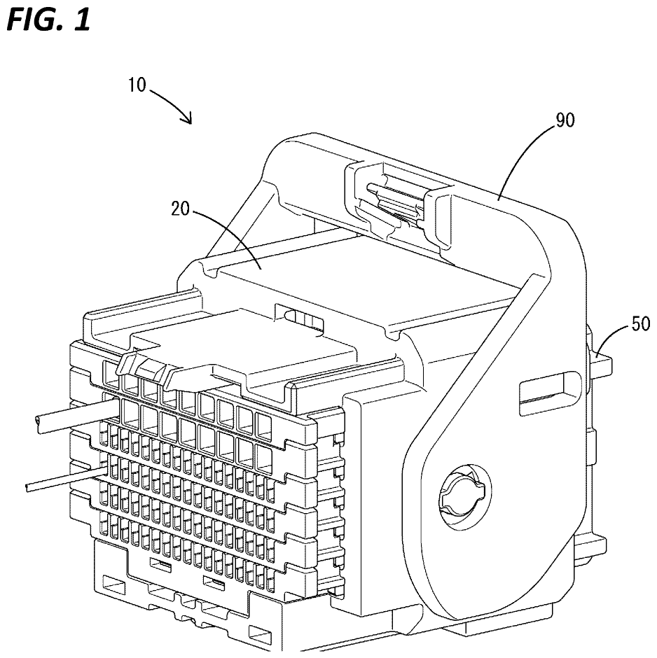

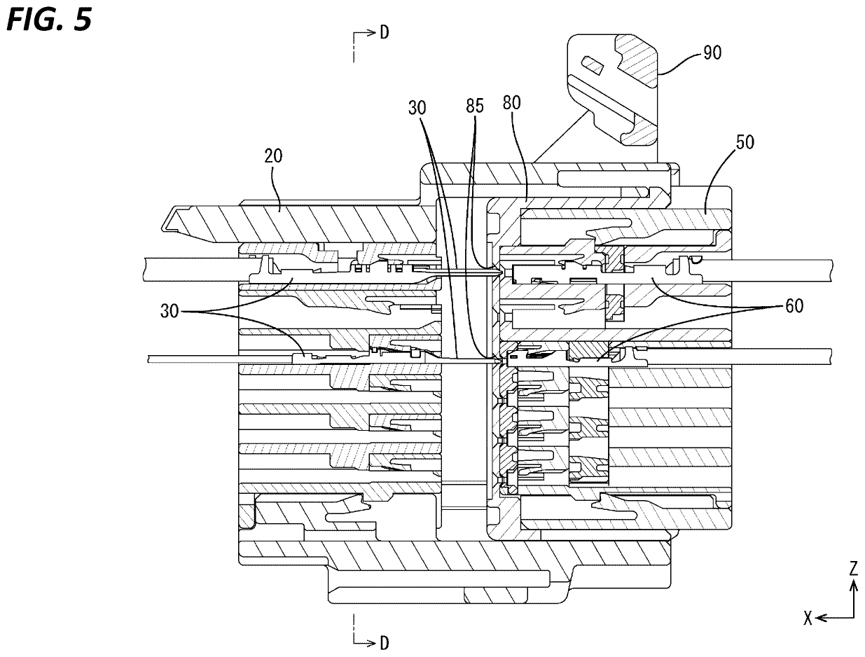

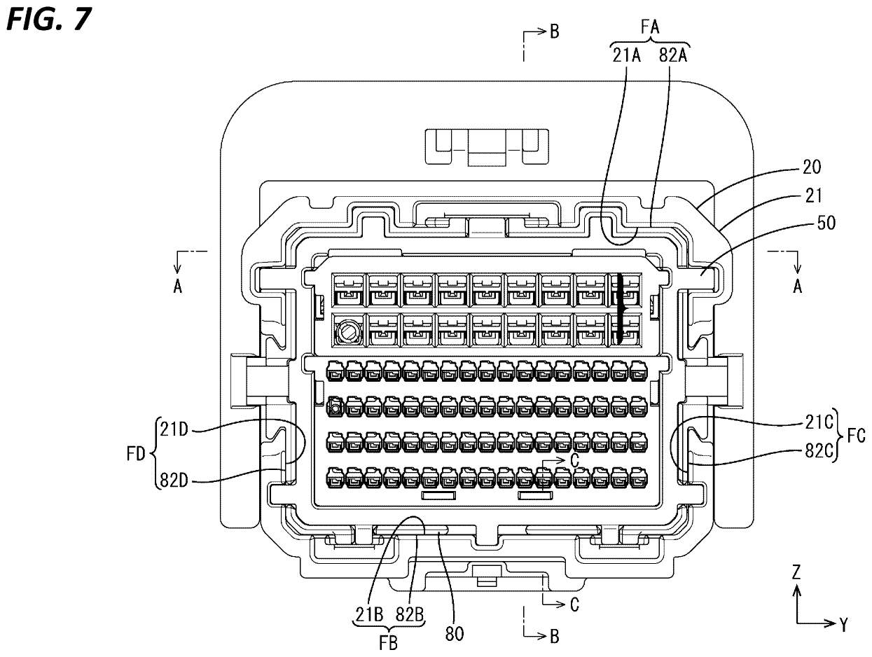

A connector of a first specific embodiment of the present disclosure is described below with reference to FIGS. 1 to 14. The present disclosure is not limited to these illustrations, but is represented by claims and intended to include all changes in the scope of claims and in the meaning and scope of equivalents. In the first embodiment, a positive direction of an X axis in FIGS. 5, 6, 10, 12 and 14 to 16 is defined as a forward direction concerning a front-rear direction. A positive direction of a Y axis in FIGS. 7 to 11 is defined as a leftward direction concerning a lateral direction. The lateral direction and a width direction are used as synonyms. A positive direction of a Z axis in FIGS. 5 to 9 and 11 to 16 is defined as an upward direction concerning a vertical direction. Note that a surface side facing a male housing 20 when the connection of a female housing 50 is started is a front side.

### 1. Configuration of Connector

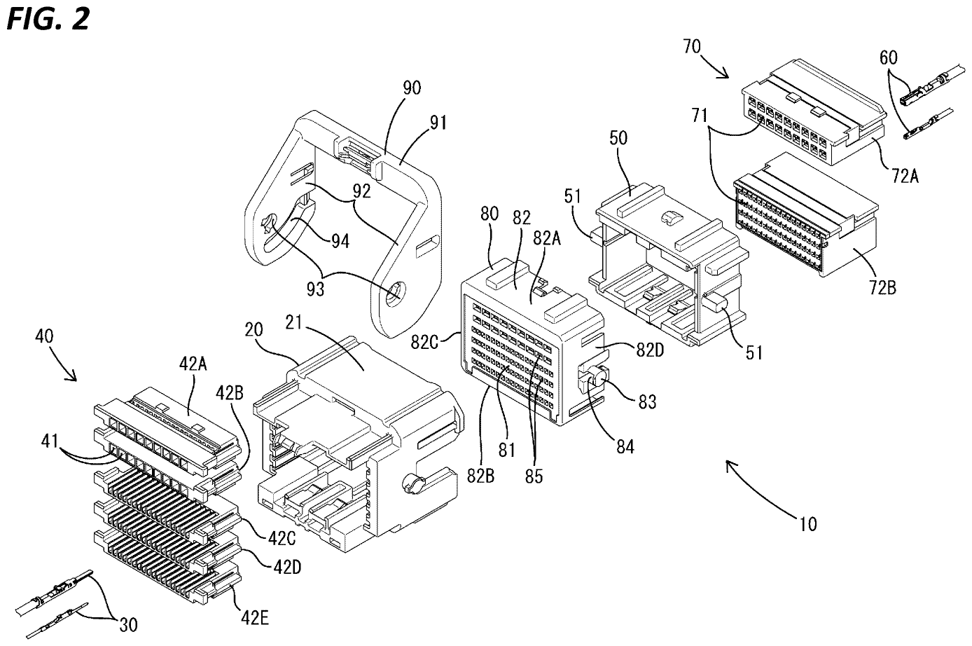

A connector 10 of the first embodiment is shown in FIG. 1. As shown in FIG. 2, the connector 10 is provided with the male housing 20, male terminal fittings 30, a male terminal holding portion 40, the female housing 50, female terminal fittings 60, a female terminal holding portion 70, a moving plate 80 and a lever 90. The male and female housings 20, 50 are connected by rotating the lever 90. By connecting the male and female housings 20, 50, the male terminal fittings 30 and the female terminal fittings 60 are connected.

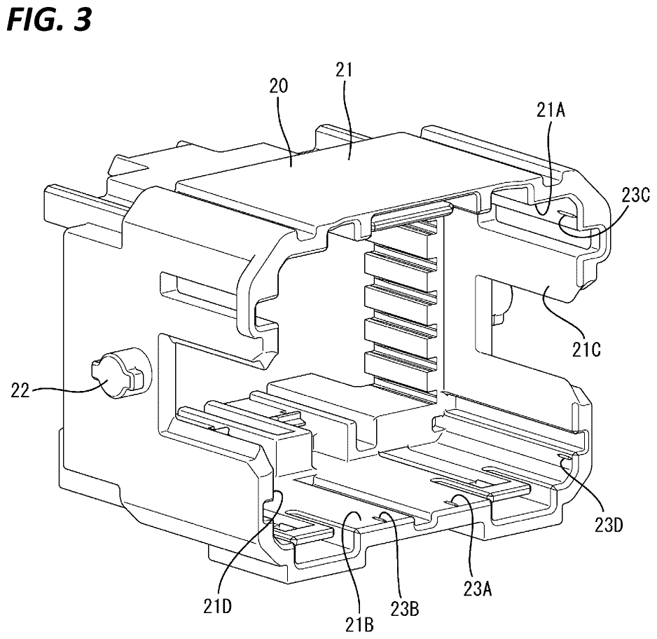

The male housing 20 corresponds to a “first component” of the present disclosure. The male housing 20 is a single component made of synthetic resin. The male housing 20 includes a receptacle 21. As shown in FIG. 3, the receptacle 21 is in the form of a rectangular tube having four inner wall surfaces (upper inner wall surface 21A, lower inner wall surface 21B, left inner wall surface 21C and right inner wall surface 21D). A pair of the inner wall surfaces (upper inner wall surface 21A and lower inner wall surface 21B) are arranged to face each other. A pair of the inner wall surfaces (left inner wall surface 21C and right inner wall surface 21D) are arranged to face each other. The male terminal fittings 30 are mounted into the male housing 20 via the male terminal holding portion 40. The lever 90 is rotatably assembled with the male housing 20. Rotary shafts 22 provided on the outer surface of the male housing 20 are fit into bearing holes 93 of the lever 90.

The male terminal holding portion 40 is made of synthetic resin. The male terminal holding portion 40 is accommodated into the male housing 20. The male terminal holding portion 40 is provided with a plurality of cavities 41. The male terminal fittings 30 are accommodated into the cavities 41. A plurality of the cavities 41 are arranged in the lateral direction in a plurality of stages in the vertical direction in the male terminal holding portion 40. The male terminal holding portion 40 includes a plurality of holding portions 42A to 42E. The holding portions 42A to 42E are in the form of plates having a rectangular shape in a plan view and stacked in the vertical direction to form the plurality of cavities 41.

The female housing 50 is made of synthetic resin. The female housing 50 is accommodated into the receptacle 21 of the male housing 20. The female terminal fittings 60 are accommodated into the female housing 50 via the female terminal holding portion 70. The female housing 50 is in the form of a rectangular tube. Projections 51 to be assembled with actuated portions 83 of the moving plate 80 are provided on the left and right outer surfaces of the female housing 50.

The female terminal holding portion 70 is made of synthetic resin. The female terminal holding portion 70 is accommodated into the female housing 50. The female terminal holding portion 70 is provided with a plurality of cavities 71. The female terminal fittings 60 are accommodated into the cavities 71. A plurality of the cavities 71 are arranged in the lateral direction in a plurality of stages in the vertical direction in the female terminal holding portion 70. The female terminal holding portion 70 includes a plurality of holding portions 72A, 72B. The holding portions 72A, 72B have a rectangular shape in a plan view and stacked in the vertical direction to form the plurality of cavities 71.

The moving plate 80 corresponds to a “second component” of the present disclosure. The moving plate 80 is a single component made of synthetic resin. The moving plate 80 is accommodated in the receptacle 21 of the male housing 20. The moving plate 80 includes a plate body portion 81 and a peripheral wall portion 82. The plate body portion 81 is in the form of a flat plate having a plate thickness direction oriented in the front-rear direction. The plate body portion 81 has a flat shape long in the lateral direction when viewed from the front-rear direction. The peripheral wall portion 82 integrally projects rearward from an outer edge part of the plate body portion 81. The peripheral wall portion 82 is in the form of a rectangular tube having four outer wall surfaces (upper outer wall surface 82A, lower outer wall surface 82B, left outer wall surface 82C and right outer wall surface 82D). A pair of the outer wall surfaces (upper outer wall surface 82A and lower outer wall surface 82B) are arranged back to back. A pair of the outer wall surfaces (left outer wall surface 82C and right outer wall surface 82D) are arranged back to back. The moving plate 80 is assembled with the male housing 20 with the upper outer wall surface 82A and the lower outer wall surface 82B respectively facing the upper inner wall surface 21 A and the lower inner wall surface 21B and with the left outer wall surface 82C and the right outer wall surface 82D respectively facing the left inner wall surface 21C and the right inner wall surface 21D. The moving plate 80 integrally moves together with the female terminal fittings 60 in the receptacle 21 in the process of connecting the male terminal fittings 30 and the female terminal fittings 60.

The actuated portions 83 are provided on the left and the right outer surfaces of the peripheral wall portion 82. Note that only the right actuated portion 83 is shown in FIG. 2. The actuated portion 83 has a cylindrical shape projecting from the outer surface of the peripheral wall portion 82. The actuated portion 83 is provided with a through hole 84 penetrating in the front-rear direction. The through hole 84 has a rectangular shape when viewed from the front-rear direction. The actuated portion 83 is in the form of a bridge extending in the vertical direction by being provided with the through hole 84. The projection 51 of the female housing 50 enters the through hole 84.

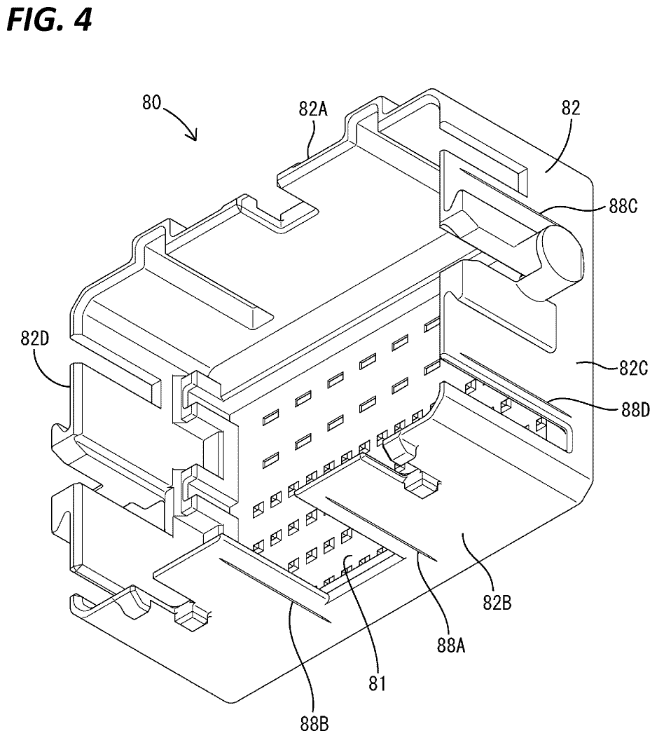

As shown in FIG. 4, projecting portions 88A to 88D are provided on the outer surface of the peripheral wall portion 82. The projecting portions 88A, 88B are provided on the lower outer wall surface 82B. The projecting portions 88C, 88D are provided on the left outer wall surface 82C. The projecting portions 88A to 88D are elongated projections extending in the front-rear direction from positions slightly behind the front end of the peripheral wall portion 82 to positions slightly in front of the rear end of the peripheral wall portion 82. A projecting amount (size in a projecting direction) of the projecting portions 88A to 88D is, for example, smaller than that (size in the projecting direction) of thread ribs 23A to 23D to be described later. The projecting portions 88A to 88D suppress the rattling of the male housing 20 and the moving plate 80 by being held in contact with the inner peripheral surface of the receptacle 21 in an assembled state of the male housing 20 and the moving plate 80. Functions of the projecting portions 88A to 88D are different from those of the thread ribs 23A to 23D to be described later.

The plate body portion 81 is provided with as many holes 85 as the male terminal fittings 30. The holes 85 penetrate through the plate body portion 81 in a thickness direction. The moving plate 80 positions tabs 31 on the tips of the male terminal fittings 30 passed through the holes 85. In the process of connecting the male housing 20 and the female housing 50, the moving plate 80 integrally moves together with the female terminal fittings 60. In this way, the tabs 31 of the male terminal fittings 30 can be positioned with high accuracy.

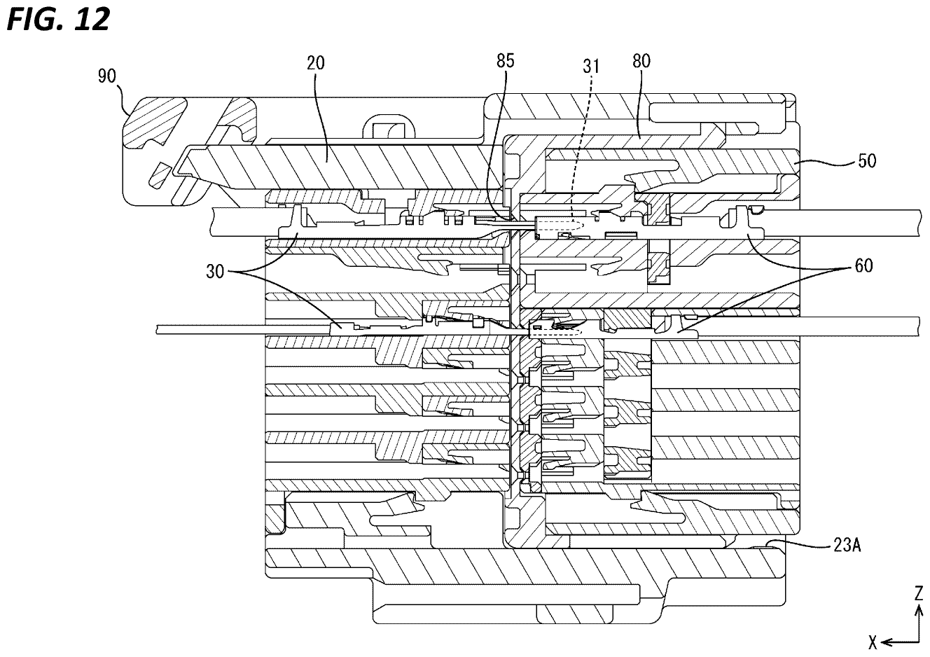

The lever 90 is a single component made of synthetic resin. The lever 90 includes an operating portion 91 and a pair of bilaterally symmetrical arm portions 92. The operating portion 91 has a shape elongated in the lateral direction. The pair of arm portions 92 extend from both left and right ends of the operating portion 91. The arm portion 92 is provided with the bearing hole 93. The bearing hole 93 is fit to the rotary shaft 22 of the male housing 20. If the operating portion 91 is gripped to apply an operation force, the lever 90 rotates about the rotary shafts 22 of the male housing 20 and rotates between a rotation start position (see FIG. 5) and a rotation completion position (see FIG. 12).

The arm portion 92 is provided with an arcuate groove portion 94 over a predetermined range around the bearing hole 93. The actuated portion 83 of the moving plate 80 and the projection 51 of the female housing 50 enter the groove portion 94. The groove portion 94 brings the actuated portion 83 and the projection 51 into sliding contact in the process of rotating the lever 90. The groove portions 94 bring the actuated portions 83 and the projections 51 into sliding contact, whereby the female housing 50 and the moving plate 80 integrally move in the receptacle 21 of the male housing 20. By rotating the lever 90 to the rotation completion position (see FIG. 12), the male housing 20 and the female housing 50 are connected and the male terminal fittings 30 and the female terminal fittings 60 are connected.

### 2. Configuration of Thread Ribs Between Male Housing and Moving Plate

As shown in FIG. 3, the receptacle 21 of the male housing 20 is provided with the thread ribs 23A to 23D. The thread rib 23A to 23D is an elongated projection projecting from the inner wall surface of the receptacle 21 and extending in the front-rear direction. The thread rib 23A to 23D has a trapezoidal shape when viewed from a direction orthogonal to the projecting direction and the front-rear direction. The thread rib 23A to 23D has a semicircular cross-sectional shape when viewed from the front-rear direction. An area of a cross-section orthogonal to the front-rear direction is reduced toward the front at the front end of the thread rib 23A to 23D. An area of a cross-section orthogonal to the front-rear direction is reduced toward the rear at the rear end of the thread rib 23A to 23D.

The moving plate 80 is assembled with the male housing 20 in parallel to a length direction (front-rear direction) of the thread ribs 23A to 23D. The thread ribs 23A to 23D prevent prying between the receptacle 21 and the moving plate 80 by being squeezed in a plastically or resiliently deformed state between the receptacle 21 and the moving plate 80.

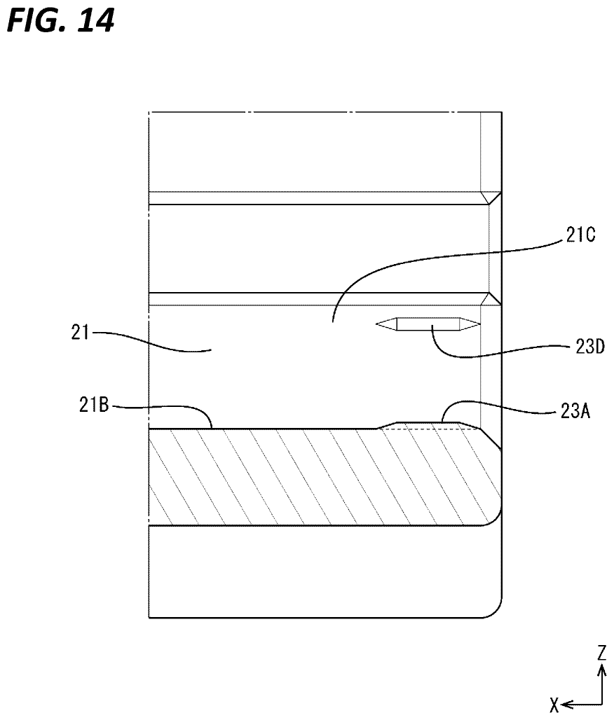

The thread ribs 23A to 23D are arranged at the same position on the inner wall surfaces of the receptacle 21 in the front-rear direction. For example, as shown in FIG. 14, the thread ribs 23A, 23D are at the same position in the front-rear direction. In this way, the thread ribs 23A to 23D are squeezed and released from a squeezed state at the same timings in the connection process of the both housings 20, 50.

### 2-1. Thread Ribs on Upper and Lower Facing Wall Surfaces

As shown in FIG. 7, the pair of inner wall surfaces (upper inner wall surface 21A, lower inner wall surface 21B) of the male housing 20 and the pair of outer wall surfaces (upper outer wall surface 82A, lower outer wall surface 82B) of the moving plate 80 constitute two sets of the facing wall surfaces (upper facing wall surface set FA, lower facing wall surface set FB). Specifically, one facing wall surface set FA (upper facing wall surface set FA) is constituted by a combination of one inner wall surface (upper inner wall surface 21A) and one outer wall surface (upper outer wall surface 82A) facing each other. Further, one facing wall surface set FB (lower facing wall surface set FB) is constituted by a combination of one inner wall surface (lower inner wall surface 21B) and one outer wall surface (lower outer wall surface 82B) facing each other.

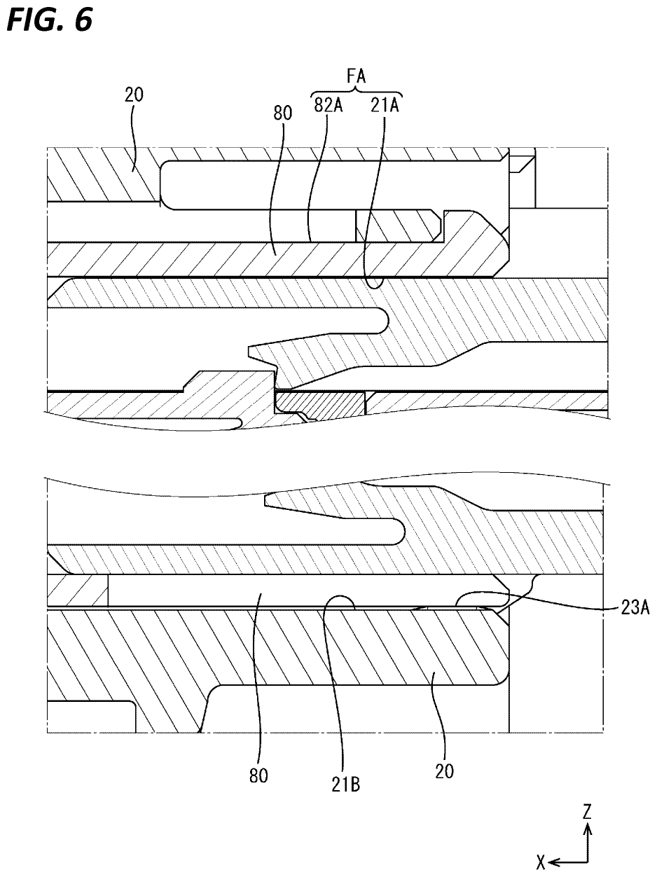

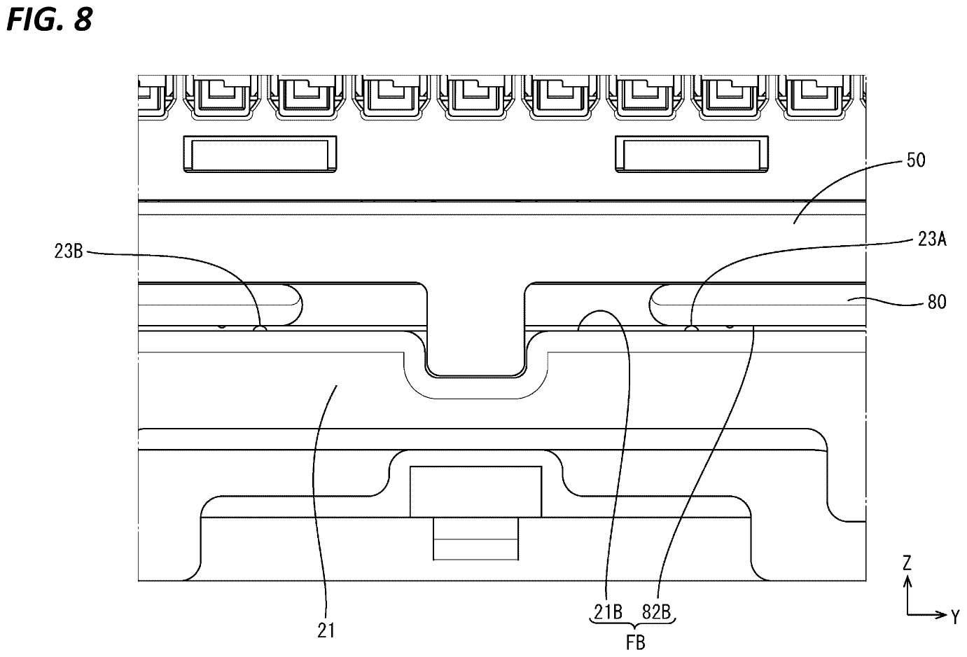

As shown in FIG. 8, the thread ribs 23A, 23B to be squeezed and deformed in the assembled state of the male housing 20 and the moving plate 80 are provided on the one facing wall surface set (lower facing wall surface set FB), out of the two facing wall surface sets (upper facing wall surface set FA, lower facing wall surface set FB). The thread ribs 23A, 23B are provided on the lower inner wall surface 21B in the lower facing wall surface set FB. The thread rib 23A is shown in FIG. 6.

The thread ribs 23A, 23B are provided to extend a predetermined distance (e.g. the same distance as a thickness of the receptacle 21) from the rear end (end part on a side where the female housing 50 is inserted) of the lower inner wall surface 21B. The thread ribs 23A, 23B are arranged on sides respectively slightly deviated from a lateral center (left and right sides) on the lower inner wall surface 21B. The thread ribs 23A, 23B are arranged at bilaterally symmetrical positions across the lateral center on the lower inner wall surface 21B.

As shown in FIGS. 6 and 7, out of the two sets of the facing wall surfaces (upper facing wall surface set FA, lower facing wall surface set FB), the facing wall surfaces (upper facing wall surface set FA) not provided with the thread ribs 23A, 23B are in contact. That is, the upper outer wall surface 82A of the moving plate 80 is in contact (surface contact) with the upper inner wall surface 21A of the male housing 20 without being deformed. In this way, in the assembled state of the male housing 20 and the moving plate 80, a positional relationship of the male housing 20 and the moving plate 80 in the vertical direction can be kept constant by the direct contact of the upper inner wall surface 21A and the upper outer wall surface 82A where the thread ribs 23A, 23B are not arranged. Further, since dimensions of other components constituting the connector 10 are allocated on the basis of the contact position (contact surfaces) of the upper inner wall surface 21A and the upper outer wall surface 82A, the accumulation of manufacturing tolerances can be suppressed.

### 2-2. Thread Ribs on Left and Right Facing Wall Surfaces

As shown in FIG. 7, the pair of inner wall surfaces (left inner wall surface 21C, right inner wall surface 21D) of the male housing 20 and the pair of outer wall surfaces (left outer wall surface 82C, right outer wall surface 82D) of the moving plate 80 constitute two sets of the facing wall surfaces (left facing wall surface set FC, right facing wall surface set FD). Specifically, one facing wall surface set FC (left facing wall surface set FC) is constituted by a combination of one inner wall surface (left inner wall surface 21C) and one outer wall surface (left outer wall surface 82C) facing each other. Further, one facing wall surface set FD (right facing wall surfaces FD) is constituted by a combination of one inner wall surface (right inner wall surface 21D) and one outer wall surface (right outer wall surface 82D) facing each other.

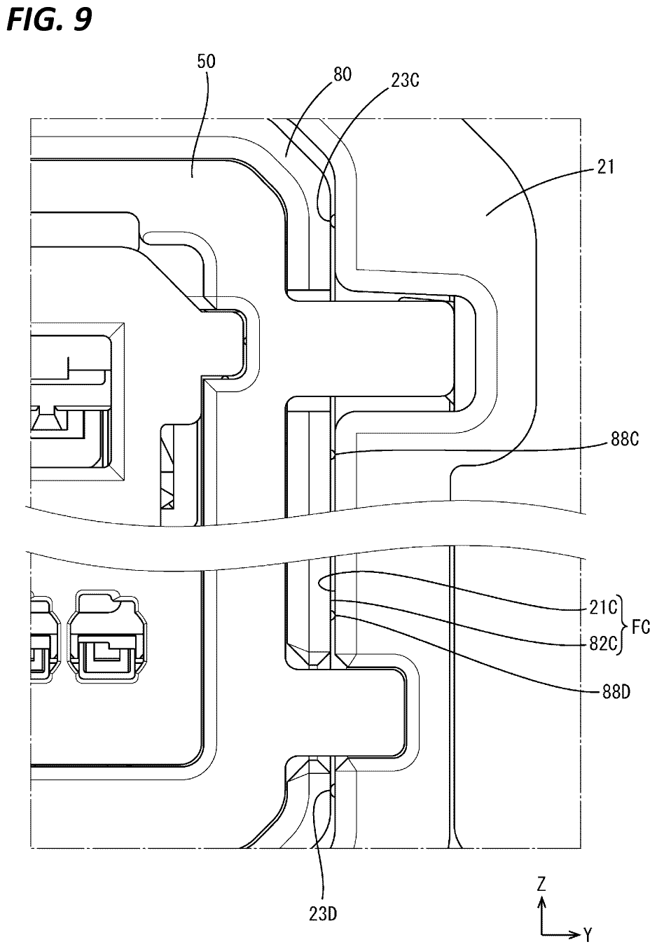

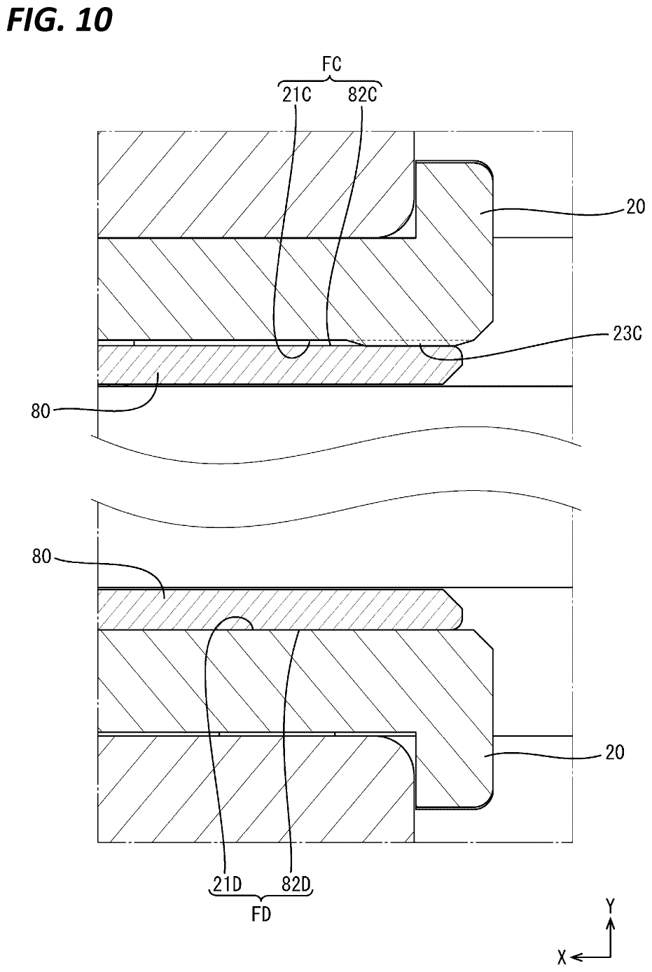

As shown in FIG. 9, the thread ribs 23C, 23D to be squeezed and deformed in the assembled state of the male housing 20 and the moving plate 80 are provided on one facing wall surface set (left facing wall surface set FC), out of the two facing wall surface sets (left facing wall surface set FC, right facing wall surface set FD). The thread ribs 23C, 23D are provided on the left inner wall surface 21C in the left facing wall surface set FC. The thread rib 23C is shown in FIG. 10.

The thread ribs 23C, 23D are provided to extend a predetermined distance (e.g. the same length in the front-rear direction as the thread ribs 23A, 23B) from the rear end (end part on the side where the female housing 50 is inserted) of the left inner wall surface 21C. The thread ribs 23C, 23D are respectively arranged near the upper end and the lower end of the left inner wall surface 21C. The thread ribs 23C, 23D are arranged at vertically symmetrical positions across a vertical center on the left inner wall surface 21C.

As shown in FIGS. 7 and 10, out of the two sets of the facing wall surfaces (left facing wall surface set FC, right facing wall surface set FD), the facing wall surfaces (right facing wall surface set FD) not provided with the thread ribs 23C, 23D are in contact. That is, the right outer wall surface 82D of the moving plate 80 is in contact (surface contact) with the right inner wall surface 21D of the male housing 20 without being deformed. In this way, in the assembled state of the male housing 20 and the moving plate 80, a positional relationship of the male housing 20 and the moving plate 80 in the lateral direction can be kept constant by the direct contact of the right inner wall surface 21D and the right outer wall surface 82D where the thread ribs 23C, 23D are not arranged.

### 2-3. Thread Ribs on Facing Wall Surfaces in Orthogonal Positional Relationship

The male housing 20 has two pairs of the inner wall surfaces (upper inner wall surface 21A and lower inner wall surface 21B, left inner wall surface 21C and right inner wall surfaces 21D) having orthogonal facing directions. The moving plate 80 includes two pairs of the outer wall surfaces (upper outer wall surface 82A and lower outer wall surface 82B, left outer wall surface 82C and right outer wall surface 82D) having orthogonal facing directions.

The thread ribs 23A to 23D are arranged only on two sets of the facing wall surfaces (lower facing wall surface set FB, left facing wall surface set FC) positioned to be orthogonal to each other, out of the two pairs of the facing wall surface sets (upper facing wall surface set FA and lower facing wall surface set FB, left facing wall surface set FC and right facing wall surface set FD). In this way, the surfaces of the upper facing wall surface set FA (upper inner wall surface 21A, upper outer wall surface 82A) are in contact in the vertical direction, and the surfaces of the right facing wall surface set FD (right inner wall surface 21D, right outer wall surface 82D) are in contact in the lateral direction. Therefore, the positional relationship of the male housing 20 and the moving plate 80 can be kept constant in two-dimensional directions (vertical direction, lateral direction) orthogonal to each other.

### 2-4. Function of Thread Ribs

The thread ribs 23A to 23D are squeezed between the receptacle 21 and the moving plate 80 before the connection of the male terminal fittings 30 and the female terminal fittings 60 is started in the process of moving the moving plate 80. A starting point of the connection of the male terminal fittings 30 and the female terminal fittings 60 is a point of time at which the male terminal fittings 30 and the female terminal fittings 60 start to contact. FIG. 5 shows a state where the connection of the male terminal fittings 30 and the female terminal fittings 60 is started. FIG. 5 is a section along B-B of FIG. 7.

FIGS. 6 to 11 show the same state (state before the connection of the both terminal fittings 30, 60 is started) as that of the connector 10 shown in FIG. 5. FIG. 6 shows a state where the thread rib 23A is squeezed between the receptacle 21 and the moving plate 80. FIG. 8 shows a state where the thread ribs 23A, 23B are squeezed. FIG. 9 shows a state where the thread ribs 23C, 23D are squeezed. FIG. 10 shows a state where the thread rib 23C is squeezed.

At the starting point of the connection of the male terminal fittings 30 and the female terminal fittings 60, the thread ribs 23A to 23D are squeezed in a plastically or resiliently deformed state between the receptacle 21 and the moving plate 80 to prevent prying between the receptacle 21 and the moving plate 80, wherefore the both terminal fittings 30, 60 can be aligned in position.

As shown in FIG. 12, the thread ribs 23A to 23D are released from the squeezed state after the connection of the male terminal fittings 30 and the female terminal fittings 60 is started. FIG. 12 shows a connection completed state of the both housings 20, 50. For example, the thread ribs 23A to 23D are released from the squeezed state after the start of the connection of the male terminal fittings 30 and the female terminal fittings 60 and before the completion of the connection. FIG. 12 shows a state where the thread rib 23A is released from the squeezed state between the receptacle 21 and the moving plate 80.

3. Configuration of Thread Ribs between Female Housing and Female Terminal Holding Portion

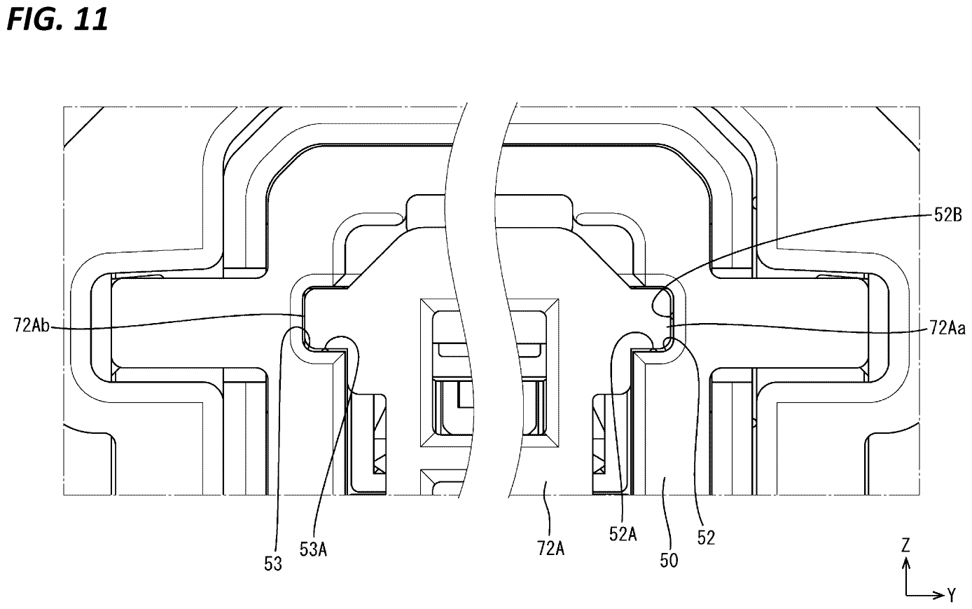

As shown in FIG. 11, the female housing 50 is provided with thread ribs 52A, 52B and 53A. The female housing 50 corresponds to an example of the “first component” of the present disclosure. The holding portion 72A of the female terminal holding portion 70 corresponds to an example of the “second component” of the present disclosure.

In the holding portion 72A of the female terminal holding portion 70, a left protrusion 72Aa and a right protrusion 72Ab are provided on left and right outer surfaces. The female housing 50 is provided with a left recess 52 and a right recess 53 respectively fit to the left protrusion 72Aa and the right protrusion 72Ab. The thread rib 52A is provided on the lower inner wall surface of the left recess 52. The thread rib 52B is provided on the left inner wall surface of the left recess 52. The thread rib 53A is provided on the lower inner wall surface of the right recess 53. The thread ribs 52A, 52B and 53A are, for example, shaped similarly to the aforementioned thread ribs 23A to 23D. The thread ribs 52A, 52B and 53A are squeezed and deformed in an assembled state of the female housing 50 and the holding portion 72A.

As shown in FIG. 11, the upper inner wall surface of the left recess 52 and the upper inner wall surface of the right recess 53 are respectively in contact with the left protrusion 72Aa and the right protrusion 72Ab. In this way, a positional relationship of the female housing 50 and the holding portion 72A in the vertical direction can be kept constant.

As shown in FIG. 11, the right inner wall surface of the right recess 53 is in contact with the right protrusion 72Ab. In this way, a positional relationship of the female housing 50 and the holding portion 72A in the lateral direction can be kept constant.

In the female housing 50, thread ribs similar to the thread ribs 52A, 52B and 53A for the holding portion 72A may be provided also on the holding portion 72B of the female terminal holding portion 70. In this case, the holding portion 72B corresponds to an example of the “second component” of the present disclosure.

### 4. Configuration of Thread Ribs Between Male Housing and Male Terminal Holding Portion

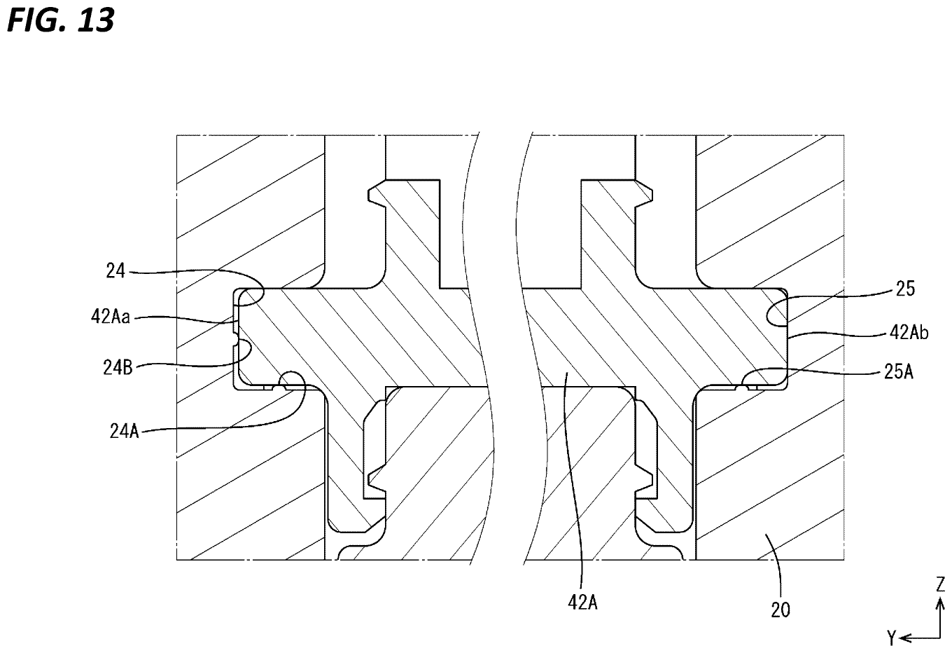

As shown in FIG. 13, the male housing 20 is provided with thread ribs 24A, 24B and 25A. The male housing 20 corresponds to an example of the “first component” of the present disclosure. The holding portion 42A of the male terminal holding portion 40 corresponds to an example of the “second component” of the present disclosure.

The male housing 20 is provided with a left recess 24 and a right recess 25 respectively fit to left and right end parts 42Aa, 42Ab of the holding portion 42A. The thread rib 24A is provided on the lower inner wall surface of the left recess 24. The thread rib 24B is provided on the left inner wall surface of the left recess 24. The thread rib 25A is provided on the lower inner wall surface of the right recess 25. The thread ribs 24A, 24B and 25A are, for example, shaped similarly to the aforementioned thread ribs 23A to 23D. The thread ribs 24A, 24B and 25A are squeezed and deformed in an assembled state of the male housing 20 and the holding portion 42A.

As shown in FIG. 13, the upper inner wall surface of the left recess 24 and the upper inner wall surface of the right recess 25 are respectively in contact with the left and right end parts 42Aa, 42Ab of the holding portion 42A. In this way, a positional relationship of the male housing 20 and the holding portion 42A in the vertical direction can be kept constant.

As shown in FIG. 13, the right inner wall surface of the right recess 25 is in contact with the right end part 42Ab of the holding portion 42A. In this way, a positional relationship of the male housing 20 and the holding portion 42A in the lateral direction can be kept constant.

In the male housing 20, thread ribs similar to the thread ribs 24A, 24B and 25A for the holding portion 42A may be provided also on the holding portions 42B to 42E of the male terminal holding portion 40. In this case, the holding portions 42B to 42E correspond to examples of the “second component” of the present disclosure.

### 5. Effects of First Embodiment

In the connector 10 of the first embodiment, the thread ribs 23A, 23B to be squeezed and deformed in the assembled state of the male housing 20 and the moving plate 80 are provided only on one set of the facing wall surfaces (e.g. lower facing wall surface set FB), out of the two sets of the facing wall surfaces (e.g. upper facing wall surface set FA, lower facing wall surface set FB). According to this configuration, in the assembled state of the male housing 20 and the moving plate 80, the inner wall surface (e.g. upper inner wall surface 21A) and the outer wall surface (e.g. upper outer wall surface 82A) in the facing wall surface set (e.g. upper facing wall surface set FA) where the thread ribs are not arranged are directly in contact, whereby the positional relationship of the male housing 20 and the moving plate 80 can be kept constant.

In the connector 10 of the first embodiment, the male housing 20 has two pairs of the inner wall surfaces (upper inner wall surface 21A and lower inner wall surface 21B, left inner wall surface 21C and right inner wall surface 21E) having the orthogonal facing directions, and the moving plate 80 has two pairs of the outer wall surfaces (upper outer wall surface 82A and lower outer wall surface 82B, left outer wall surface 82C and right outer wall surface 82E) having the orthogonal facing directions. The thread ribs 23A to 23D are arranged only on two sets of the facing wall surfaces (lower facing wall surface set FB, left facing wall surface set FC) positioned to be orthogonal to each other, out of the two pairs of the facing wall surface sets FA to FD. According to this configuration, the positional relationship of the male housing 20 and the moving plate 80 can be kept constant in the two-dimensional directions (vertical direction, lateral direction) orthogonal to each other.

### Second Embodiment

A connector of a second embodiment is different from that of the first embodiment in the arrangement of thread ribs. The same components as in the first embodiment are denoted by the same reference signs and not described in detail.

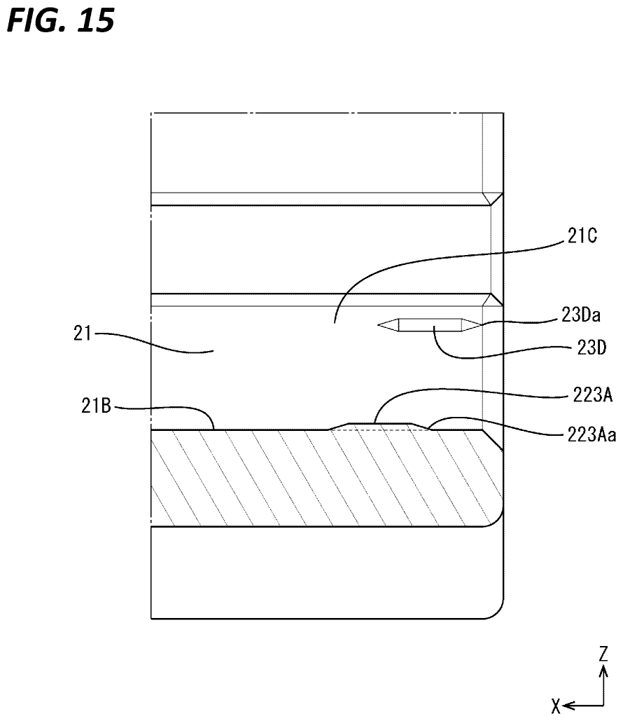

In the connector of the second embodiment, the front end positions in an assembly direction of a plurality of thread ribs are different among the plurality of thread ribs. For example, as shown in FIG. 15, a thread rib 223A is provided instead of the thread rib 23A of the first embodiment. A part of the thread rib 223A is at a position overlapping a thread rib 23D in the front-rear direction. In a receptacle 21, the position of a front end 223 Aa in the assembly direction of the thread rib 223A is located behind a front end 23Da in the assembly direction of the thread rib 23D in the assembly direction. Here, the assembly direction of the receptacle 21 is a moving direction (negative direction of the X axis) of a moving plate 80 to be assembled.

In the process of assembling a male housing 20 and the moving plate 80, connection resistance due to the squeezing deformation of the thread ribs 223A and 23B to 23D is maximum when the squeezing deformation of the thread ribs 223A and 23B to 23 starts. Thus, a peak value of the connection resistance can be reduced by making a formation range of the thread rib 223A and those of the thread ribs 23B to 23D in the assembly direction different.

### Other Embodiments

The present invention is not limited to the above described and illustrated embodiment, but is represented by claims. The present invention includes all changes in the scope of claims and in the meaning and scope of equivalents and also includes the following embodiments.

Although the thread ribs are provided on the two sets of the facing wall surfaces (lower facing wall surface set FB, left facing wall surface set FC) in the above embodiments, thread ribs may be provided only on either one set of the facing wall surfaces.

Although the thread rib is provided only on one facing wall surface (inner wall surface on the first component side) in the above embodiments, thread rib(s) may be provided on the other facing wall surface (outer wall surface on the second component side) or on the both facing wall surfaces.

In the above embodiments, the number of the thread ribs formed on one first component is not particularly limited and may be only one or two or more.

In the above embodiments, the number of the thread ribs formed on the wall surface along the width direction (lateral direction) is not particularly limited and may be only one or three or more.

In the above first embodiment, the thread ribs 23A to 23D are arranged at the same position in the front-rear direction on the inner wall surfaces of the receptacle 21, but some or all of the thread ribs 23A to 23D may be located at positions different in the front-rear direction.

Although the front end 223A in the assembly direction of the thread rib 223A is located behind the front end 23Da in the assembly direction of the thread rib 23D in the assembly direction in the second embodiment, the front end 223Aa may be located in front of the front end 23Da in the assembly direction.

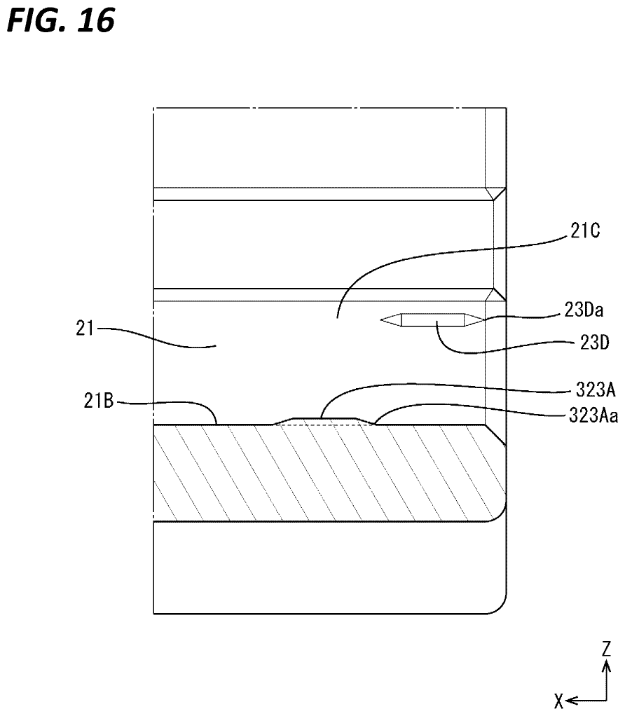

Although the thread rib 223A is partially at the position overlapping the thread rib 23D in the front-rear direction in the above second embodiment, a thread rib 323A may be configured not to overlap the thread rib 23D as shown in FIG. 16. The position of a front end 323Aa in the assembly direction of the thread rib 323A is located behind the front end 23Da in the assembly direction of the thread rib 23D in the assembly direction. The thread rib 323A and the thread rib 23D are arranged side by side in the front-rear direction not to overlap each other.

### LIST OF REFERENCE NUMERALS

10 . . . connector
20 . . . male housing (first component)
21 . . . receptacle
21A . . . upper inner wall surface (inner wall surface)
21B . . . lower inner wall surface (inner wall surface)
21C . . . left inner wall surface (inner wall surface)
21D . . . right inner wall surface (inner wall surface)
22 . . . rotary shaft
23A to 23D . . . thread rib
23Da . . . front end in assembly direction
24 . . . left recess
24A, 24B, 25A . . . thread rib
25 . . . right recess
30 . . . male terminal fitting
31 . . . tab
40 . . . male terminal holding portion
41 . . . cavity
42A to 42E . . . holding portion (second component)
42Aa . . . left end part
42Ab . . . right end part
50 . . . female housing (first component)
51 . . . projection
52 . . . left recess
52A, 52B, 53A . . . thread rib
53 . . . right recess
60 . . . female terminal fitting
70 . . . female terminal holding portion
71 . . . cavity
72A, 72B . . . holding portion (second component)
72Aa . . . left protrusion
72Ab . . . right protrusion
80 . . . moving plate (second component)
81 . . . plate body portion
82 . . . peripheral wall portion
82A . . . upper outer wall surface (outer wall surface)
82B . . . lower outer wall surface (outer wall surface)
82C . . . left outer wall surface (outer wall surface)
82D . . . right outer wall surface (outer wall surface)
83 . . . actuated portion
84 . . . through hole
85 . . . hole
88A to 88D . . . projecting portion
90 . . . lever
91 . . . operating portion
92 . . . arm portion
93 . . . bearing hole
94 . . . groove portion
223A . . . thread rib
223Aa . . . front end in assembly direction
323A . . . thread rib
FA . . . upper facing wall surface set (facing wall surface set)
FB . . . lower facing wall surface set (facing wall surface set)
FC . . . left facing wall surface set (facing wall surface set)
FD . . . right facing wall surface set (facing wall surface set)

1. A connector, comprising:
a first component having a pair of inner wall surfaces arranged to face each other; and
a second component having a pair of outer wall surfaces arranged back to back, the second component being assembled with the first component with the pair of outer wall surfaces caused to face the pair of inner wall surfaces,
the pair of inner wall surfaces and the pair of outer wall surfaces constituting two sets of facing wall surfaces, a combination of one inner wall surface and one outer wall surface facing each other being one set, and
a thread rib to be squeezed and deformed in an assembled state of the first component and the second component being provided only on one set of the facing wall surfaces, out of the two sets of the facing wall surfaces.

2. The connector of claim 1, wherein:
the first component has two pairs of the inner wall surfaces having orthogonal facing directions,
the second component has two pairs of the outer wall surfaces having orthogonal facing directions, and
the thread ribs are arranged only on two sets of the facing wall surfaces positioned to be orthogonal to each other, out of two pairs of facing wall surface sets.

3. The connector of claim 1, wherein:
the first component and the second component are assembled in parallel in a length direction of the thread rib,
the first component includes a plurality of the thread ribs, and
positions of front ends in an assembly direction of the plurality of thread ribs are different among the plurality of thread ribs.
